(19) United States
(12) Patent Application Publication
(10) Pub. No.: US 2017/0272343 A1
(43) Pub. Date: Sep. 21, 2017

(54) SYSTEMS AND METHODS FOR MONITORING SERVERS FOR OVERLOADING CONDITIONS

(71) Applicant: CA, INC., New York, NY (US)

(72) Inventor: Nicholas Robert Giles, Hessle (GB)

(73) Assignee: CA, INC., New York, NY (US)

(21) Appl. No.: 15/075,489

(22) Filed: Mar. 21, 2016

(51) Int. Cl. H04L 12/26; H04L 29/08

(52) U.S. Cl. CPC H04L 43/10; H04L 43/0888; H04L 43/0852; H04L 67/02

(57) ABSTRACT

A method is disclosed that includes monitoring, at a network traffic analyzer, service requests transmitted to a network server, and service responses to the service requests transmitted by the network server, measuring an average latency associated with the service requests, a throughput rate associated with service responses, and a concurrency of service requests being handled by the network server, determining that a target concurrency of the service requests has been exceeded by a predetermined threshold, and in response to determining that the target concurrency of the service requests has been exceeded by the predetermined threshold, selectively intercepting a subsequent service request transmitted to the network server.

### BACKGROUND

Field of the Invention

Embodiments of the inventive concepts relate to client/server computing system administration, and in particular to managing loads on client/server computing systems.

Background Art

In client/server communication systems, client applications or devices (“clients”) transmit requests via computer communication networks to servers, which process the requests and send responses back to the clients. An example of a commonly-used client/server system is a HTTP server system, in which a client, such as an internet browser, send HTTP requests to a HTTP server. The HTTP server processes the request and sends a response back to the internet browser. The response may include, for example, a web page, or an element of a web page.

A server system may be implemented as a server farm, or server cluster, which includes a plurality of servers that process service requests. A server farm typically has a single front-end address that receives service requests, such as HTTP requests, and then routes the request to an available server for processing. An example of a conventional server cluster 110 is shown in FIG. 1. The server cluster 110 includes a plurality of HTTP servers 120 in communication with a load balancer 130. The load balancer provides an interface to a communications network 140, which may be an internet protocol (IP) based computer communication network. A plurality of client applications 150 are connected to the communications network 140. The client applications 150 may, for example, be internet browsers installed on computing devices. The client applications 150 send HTTP requests through the IP network 140 to an internet address associated with the server cluster 110. The HTTP requests are received by the load balancer 130 and routed to one of the HTTP servers 120 for processing.

The decision to route a request to a particular server can be handled a number of ways. In one implementation, service request are routed to servers 120 in the server cluster 110 on a round-robin assignment basis. In another implementation, service request are routed to servers 120 in the server cluster 110 on the basis of server availability or capacity. In either case, when the arrival rate of service request exceeds the rate at which the servers in the server cluster 110 can process the requests, one or more of the servers in the server cluster 110 can become overloaded.

In particular, incoming requests are buffered in the HTTP servers 120 until they can be processed. As the buffers in the servers become full, more processing resources are required to manage the buffers, which further reduces the response time of the servers 120 and exacerbates the problem of overloading. This can have a snowball effect that can eventually lead to one or more of the servers 120 crashing, to service requests being dropped, or both.

Monitoring the health or operating conditions of a network server, such as a HTTP server 120 is complicated due to wide variation in tasks the server is requested to perform, the variation in resources needed to complete those requests and the variation in the arrival of these requests.

### SUMMARY

A method according to some embodiments includes monitoring, at a network traffic analyzer, service requests transmitted to a network server, and service responses to the service requests transmitted by the network server, measuring an average latency associated with the service requests, a throughput rate associated with service responses, and a concurrency of service requests being handled by the network server, determining a relationship of the throughput rate to the concurrency based on a plurality of measurements of the throughput rate and the concurrency, generating an effective latency based on the relationship of the throughput rate to the concurrency, comparing the effective latency to the average latency, and selectively intercepting a subsequent service request transmitted to the network server based on the comparison of the effective latency to the average latency.

Comparing the effective latency to the average latency may include determining that the effective latency is greater than the average latency by at least a threshold amount.

Comparing the effective latency to the average latency may include generating a metric based on the effective latency and the average latency and comparing the metric to a target value.

The metric may include a warning factor, wf, calculated as

wf=1−Wavg/Weff

where Wavg is the average latency and Weff is the effective latency.

The method may further include storing a service request that is intercepted in a service request queue as a queued service request.

The method may further include determining that the effective latency is no longer greater than the average latency by at least a threshold amount, and responsive to determining that the effective latency is no longer greater than the average latency by at least the threshold amount, transmitting the queued service request to the network server.

The method may further include, in response to determining that the effective latency is greater than the average latency by at least the threshold amount, intercepting a subsequent service response transmitted by the network server and storing the service response in a service response queue as a queued service response.

The method may further include determining that the effective latency is no longer greater than the average latency by at least the threshold amount, and transmitting the queued service response to a recipient associated with the queued service response.

The method may further include transmitting the queued service response to a recipient associated with the service response after a predetermined delay.

The method may further include, in response to determining that the effective latency is greater than the average latency by at least the threshold amount, receiving a subsequent service request and responsively transmitting a message to a sender of the subsequent service request indicating that the network server is delayed.

The method may further include, in response to determining that the effective latency is greater than the average latency by at least the threshold amount, transmitting a message to a server manager indicating that the network server has exceeded a target concurrency.

The method may further include, in response to determining that the effective latency is greater than the average latency by at least the threshold amount, increasing resources allocated to the network server.

The resources available to the network server include at least one of CPU utilization level, network bandwidth, and/or memory resources.

Determining the relationship of the throughput rate to the concurrency based on a plurality of measurements of the throughput rate and the concurrency may include fitting a linear curve to the plurality of measurements of the throughput rate and the concurrency and determining a slope of the linear curve.

An inverse slope of the linear curve may be defined to correspond to the effective latency.

The method may further include determining that the effective latency is greater than the average latency by at least a threshold amount, and in response to determining that the effective latency is greater than the average latency by at least the threshold amount, intercepting subsequent service requests transmitted to the network server and transmitting the intercepted subsequent service requests to the network server, the subsequent requests are received as a time-varying random distribution of requests and are transmitted to the network server as a homogeneous sequence of non-time-varying requests.

The method may further include determining that the effective latency is greater than the average latency by at least a threshold amount, and in response to determining that the effective latency is greater than the average latency by at least the threshold amount, intercepting subsequent service requests transmitted to the network server and transmitting the intercepted subsequent service requests to the network server with pacing.

A method according to further embodiments includes monitoring, at a network traffic analyzer, service requests transmitted to a network server, and service responses to the service requests transmitted by the network server, measuring an average latency associated with the service requests, a throughput rate associated with service responses, and a concurrency of service requests being handled by the network server, determining that a target concurrency of the service requests has been exceeded by a predetermined threshold, and in response to determining that the target concurrency of the service requests has been exceeded by the predetermined threshold, selectively intercepting a subsequent service request transmitted to the network server.

Determining that the target concurrency of the service requests has been exceeded by a predetermined threshold may include generating an effective latency based on a relationship of the throughput rate to the concurrency, the relationship is based on a plurality of measurements of the throughput rate and the concurrency, and comparing the effective latency to the average latency.

A network traffic analyzer according to some embodiments includes a processor, a memory coupled to the processor, and a network interface configured to receive service requests that are transmitted to a network server. The memory includes computer readable program code that is executable by the processor to perform determining that a target concurrency of the service requests being processed by the network server has been exceeded by a predetermined threshold, and in response to determining that the target concurrency of the service requests has been exceeded by the predetermined threshold, intercepting a subsequent service request transmitted to the network server.

### BRIEF DESCRIPTION OF THE DRAWINGS

FIG. 1 is a block diagram of a conventional client/server system.

FIG. 2 is a graph of throughput versus concurrency for a client/server system.

FIG. 3 is a graph of average response time versus concurrency for a client/server system.

FIG. 4 is a graph of throughput versus concurrency for a client/server system under various types of loads.

FIG. 5 is a block diagram of a client/server system including a network traffic analyzer according to some embodiments.

FIG. 6 is a graph of throughput versus concurrency for a client/server system that is operating below a target level of concurrency.

FIG. 7 is a graph of throughput versus concurrency for a client/server system that is operating above a target level of concurrency.

FIG. 8 is a flowchart illustrating operations of a network traffic analyzer according to some embodiments.

FIG. 9 is a block diagram of a client/server system including a network traffic analyzer according to further embodiments.

FIG. 10 is a flowchart illustrating operations of a network traffic analyzer according to some embodiments.

FIG. 11 is a block diagram of a network traffic analyzer according to some embodiments.

FIGS. 12-16 are simulation graphs that illustrate system reaction times under various conditions.

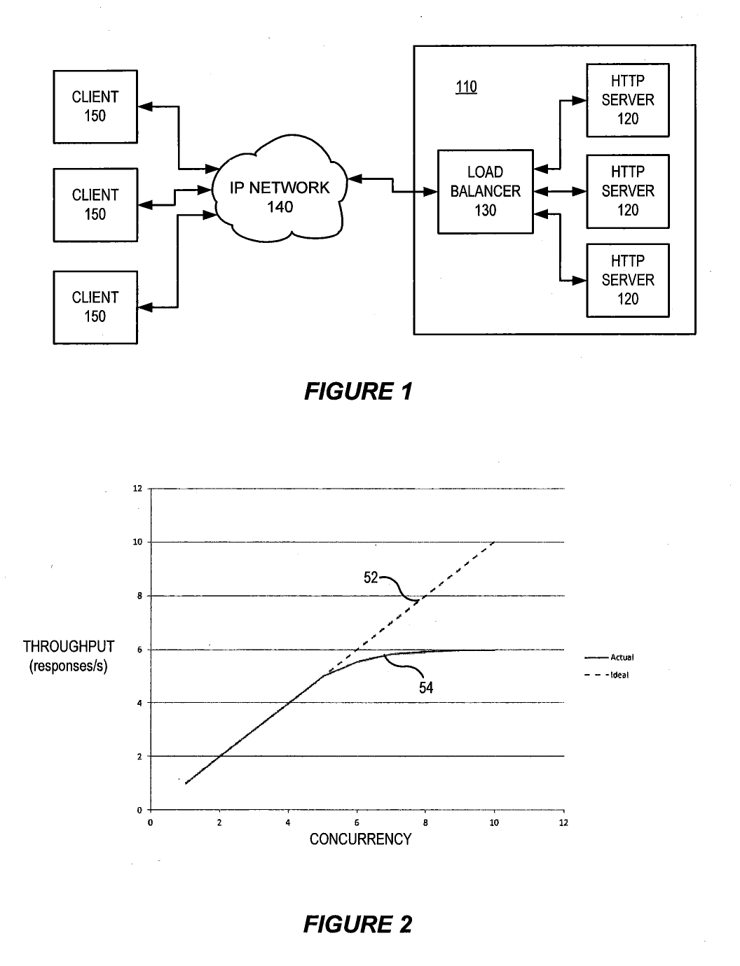

### DETAILED DESCRIPTION OF EMBODIMENTS

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Some embodiments of the inventive concepts are directed to systems and/or methods for handling service requests received at a server farm, such as a web cluster. However, the inventive concepts are not limited to web clusters, but can be advantageously applied to any client/server environment. Some embodiments of the inventive concepts provide a network traffic analyzer that monitors service requests transmitted to a network server, and service responses to the service requests transmitted by the network server. The network traffic analyzer measures a latency associated with the service requests, a throughput rate associated with service responses, and a concurrency of service requests being handled by the network server. Using this information, the network traffic analyzer determines whether the network server has exceeded a target concurrency. If the target concurrency has been reached, the system can selectively intercept subsequent service requests addressed to the network server until the concurrency has been reduced to a level that can be handled by the network server.

In this context, “throughput” refers to the average number of HTTP responses sent from a network server per unit time. “Latency” refers to the average length of time between a request arriving at the network server and a response to the request being sent from the network server (not including transport times for request arrival and response sending). “Concurrency” refers to the average number of requests being processed concurrently by the network server. “Arrival rate” refers to the rate at which requests arrive at the network server. Concurrency provides a measure of a current load on a network server, while throughput and latency indicate the capacity of the network server to handle requests.

Some embodiments of the inventive concepts monitor these variables and use them to determine when an HTTP server is about to exceed its operational limits and make appropriate adjustments before experiencing performance degradation in terms of increased latency due to the volume of incident traffic.

In particular, embodiments of the inventive concepts monitor the behavior of an HTTP server with regard to throughput, concurrency and latency. When the load on a network server is low, there is generally a linear relationship between concurrency and throughput, with the constant of proportionality being the arrival rate. This is described by Little's Law as follows:

L=λW [1]

where L refers to the average stable concurrency, W is the average latency, and λ is the average arrival rate.

While not wishing to be bound by a particular theory, it is presently understood that for any homogeneous stream of requests there exists a concurrency level after which the linear relationship between concurrency and throughput as described by Little's Law breaks down. That is, as the concurrency rises, the system reaches a point where the throughput no longer increases in proportion to the concurrency. This effect is illustrated in FIG. 2 which is a graph of simulated throughput (number of responses/second) of a server as a function of concurrency (number of pending requests). In FIG. 2, curve 52 represents an ideal case that follows Little's Law regardless of concurrency. However, the actual throughput, represented by curve 54, indicates that at some level of concurrency, the throughput ceases to be linearly related to concurrency, and starts to level off, which indicates that the system has become overloaded.

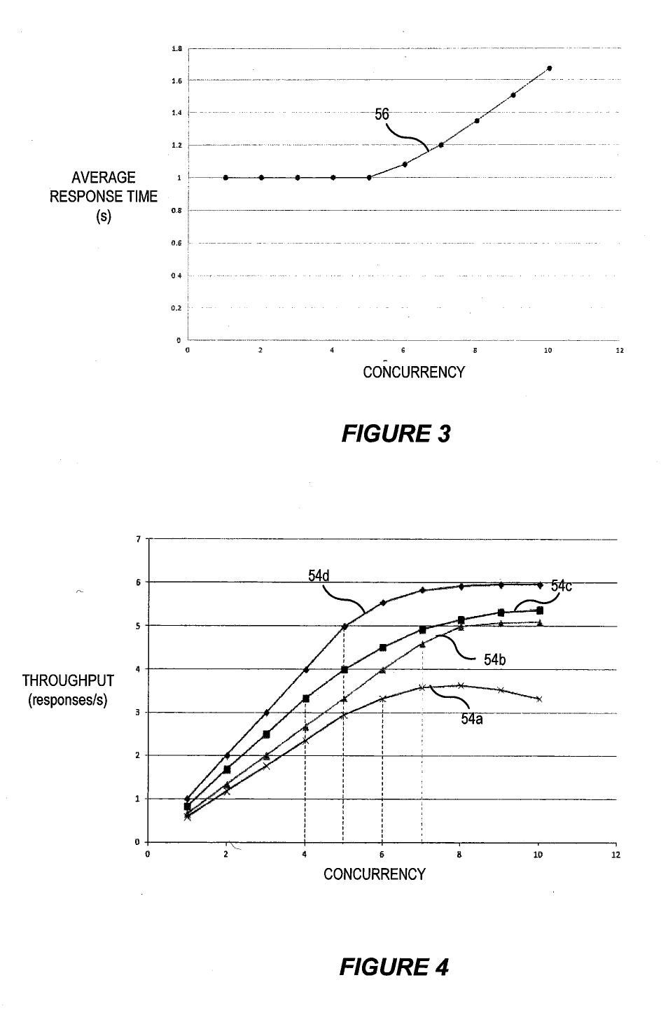

Moreover, when the system starts to become overloaded, the average response time will start to increase, as illustrated in FIG. 3, which is a graph (curve 56) of average response time as a function of concurrency. As shown in FIG. 3, when the concurrency is low, the average response time remains generally constant. However, when the concurrency increases beyond a threshold level, the average response time starts to increase as the server starts to receive requests at a faster rate than it can process them.

Deviation from Little's Law essentially indicates that request times are increasing due to overheads incurred by the level of concurrency, such as context switching or the saturation of resources, such as RAM or storage IO, in the network server. This deviation is important, as it is a precursor to system instability whereby the arrival rate begins to outstrip the throughput. This condition causes positive feedback, which can saturate the HTTP server to a point where it either crashes or stops responding to HTTP requests. Such a condition is sometimes referred to as a “blowout.”

The graph shown in FIG. 2 shows that the point at which deviation from observation of Little's Law occurs can easily be determined for a system receiving a homogeneous stream of requests. However, in real systems, the arrival of requests may not be homogeneous, so determining when the point of deviation has been reached is not straightforward. For example, FIG. 4 illustrates various relationships (curves 54a to 54d) between concurrency and throughput that may be experienced by a network server depending on the amount of processing needed to fulfill each request and the arrival rate of the requests. As can be seen in FIG. 4, the point at which an optimum level of concurrency is reached may vary as a function of time as the types and arrival rates of the requests changes. For each of the four curves 54a to 54d there is a different point at which the throughput vs concurrency curve deviates from Little's Law. Therefore, there is not a single level of concurrency that can be identified as a maximum, optimal or target concurrency after which the system stops obeying Little's Law.

Some embodiments of the inventive concepts may reliably determine if the point of deviation from Little's Law has been reached for a system receiving a time-varying, random distribution of requests when the arrival of requests follows a Poisson process, i.e. when the inter-arrival times are randomly distributed and requests arrive independently of each other.

Furthermore, according to some embodiments, the level or degree of deviation from Little's Law can be quantified. This information can be used as an indication of how close the system is to becoming unstable. For example, the degree of deviation from Little's Law can be used to determine what increase in arriving traffic can be handled before instability occurs or simply when a required performance metric, such as a maximum average response time, will be reached or exceeded.

Some embodiments of the inventive concepts determine when a network server is nearing or reaches a target concurrency at which the linear relationship between throughput and concurrency starts to break down. Identifying this point can provide an early indication of a potential system instability. The systems/methods can then take appropriate action to reduce the load on the network server before it becomes unstable.

In the following description, an HTTP server is modeled as an HTTP request processor. However, a cluster of HTTP servers that serves a single request queue may be monitored in this manner and the performance of the cluster can be measured in the same way.

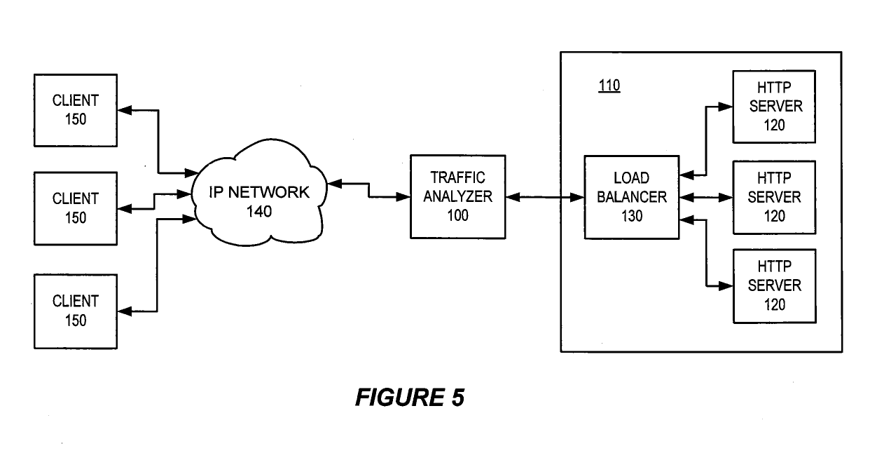

FIG. 5 illustrates a system including network traffic analyzer 100 that is configured to determine when a network server, or cluster of network servers, has reached a target level of concurrency. As shown in FIG. 5, the network traffic analyzer 100 may be situated between the IP network 140 and the server cluster 110, where it can act as a proxy for the server cluster 110. The network traffic analyzer 100 monitors requests received by the server cluster 110 and responses sent by servers in the server cluster 110. Although illustrated as a separate entity, the network traffic analyzer 100 may in some cases be implemented within the load balancer 130 and/or within the server cluster 110. In some embodiments, the network traffic analyzer 100 may be implemented in front of or as part of a single web server 120 where it can monitor the request/response traffic of a single web server 120.

The network traffic analyzer 100 monitors requests received by the server cluster 110 and responses sent by servers in the server cluster 110 and measures the latency, throughput and concurrency of requests being handled by the server cluster 110. From this information, the network traffic analyzer 100 may generate rolling averages of the latency, throughput and concurrency of requests to determine whether a target concurrency for the server cluster 110 has been reached.

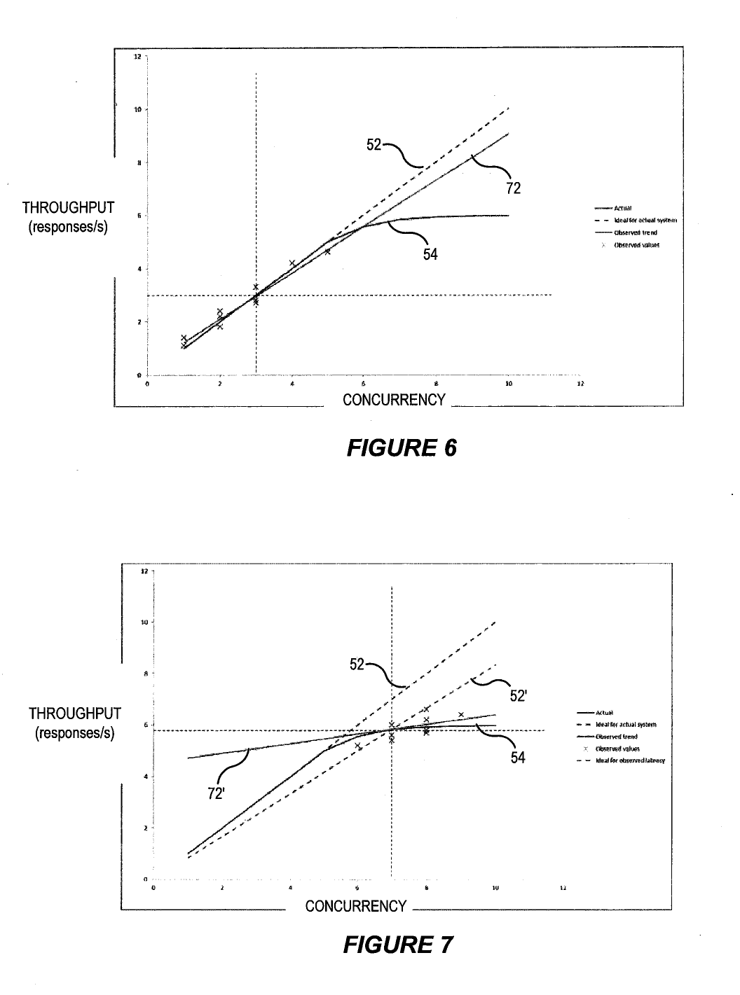

Referring to FIG. 6, concurrency and throughput of a simulated HTTP server are measured, and the measured points of concurrency and throughput are plotted on a plane. Curve 52 represents an ideal relationship between concurrency and throughput for the HTTP server, while curve 54 represents an actual relationship between concurrency and throughput for the HTTP server. A line of best-fit via linear regression is obtained from the measured points and plotted as a line 72 that has a gradient (slope) that is equal the reciprocal of average response time for an HTTP server observing Little's Law.

An “optimum” concurrency for an HTTP server is defined as, the maximum concurrency which can be handled beyond which a degradation in latency is observed. This is the point at which Little's Law no longer holds, and there is no longer a linear relationship between concurrency and throughput.

When the inverse gradient of the line 72 is above the average measured latency, this indicates the HTTP server is operating beyond the point at which Little's Law holds, and therefore is beyond its optimum concurrency (or a target concurrency defined for the system). In the example shown in FIG. 6, the system is below optimum concurrency, that is, it is following Little's Law. That is, using the system and conditions described above as the actual system behavior (“Actual”) as represented by curve 54, the graph above shows points (“x”) of measured concurrency and throughput (“Observed values”). Using linear regression, a trend line 72 (“Observed trend”) can be derived. The inverse of the gradient of this line is 1.15, which is close to the measured average latency of 1, so it can be determined that the system is operating in accordance with Little's Law. That is, even though the inverse gradient of the trend line 72 is greater than the measured latency, it can be determined that the system is operating below a target concurrency level.

In particular embodiments, a threshold may be established such that if inverse gradient of the trend line 72 is less than the measured average latency or within a threshold distance of the measured average latency, the system is considered to be operating in a stable region. However, if the inverse gradient of the trend line 72 exceeds the measured average latency by more than the threshold, the system may be considered to be operating beyond its optimum or target concurrency.

In contrast to the example of FIG. 6, FIG. 7 illustrates a graph of throughput vs. concurrency for a simulated system that has exceeded the optimum concurrency and is no longer following Little's Law. In particular, for the system of FIG. 7, the line 52′ represents the optimum behavior of the system for the observed latency. Line 72′ represents a best-fit via linear regression for the observed values of throughput and concurrency. Because the inverse gradient of line 72′ is significantly greater than the observed latency, it can be recognized that the system has passed the optimum concurrency or the target concurrency.

In the example illustrated in FIG. 7, it can be seen that the gradient of the trend line 72′ derived from the measured points of concurrency and throughput (“Observed trend”) deviates significantly from the gradient of the expected trend if the system were adhering to Little's Law for the given measured throughput, concurrency and latency (“Ideal for observed latency”). This significant departure from what would be expected indicates that the system is operating in a region in which it can no longer adhere to Little's Law. Therefore, it can be concluded that the optimum or target concurrency has been exceeded, which is what can be seen when the actual system characteristics (“Actual”) of curve 54 are compared.

By comparing the inverse gradient of line 72 or 72′ to the average latency, a reliable determination of the breakdown of Little's Law can be made in spite of the varying nature of requests and their arrival characteristics. An indication of the breakdown of Little's Law, and the level of deviation from Little's Law, are useful metrics for determining the operating capacity of an HTTP server.

The average latency may be calculated as a rolling average based on historical values to smooth out anomalies and highlight statistically relevant changes. The reaction time of the network traffic analyzer 100 to the average latency may be tuned to increase the reliability of the final indication of system behavior.

Values for throughput, latency and concurrency of the system may be obtained at regular time intervals by the network traffic analyzer 100. Raw values, i.e. not rolling average values, for concurrency and throughput for the last χ samples may be plotted on a virtual plane. Using a linear regression technique (such as the Theil-Sen estimator), a trend line can be drawn between the samples. The gradient of this line should be equal to the inverse of the current observed average latency provided the system is exhibiting behavior in accordance with Little's Law.

According to some embodiments, a metric wf (or warning factor) may be derived that indicates a level of deviation from the optimum or target concurrency. The metric may be used by the network traffic analyzer to decide how to respond to the operating condition of the HTTP server.

This metric wf may be derived from the difference in gradients of the observed trend and the ideal for the actual system if it were following Little's Law. The gradient of the line describing concurrency and threshold should Little's Law hold is the reciprocal of the current average latency, so the metric wf can be calculated as follows:

$$wf = ( \frac{{W}_{avg}^{- 1} - ∇ T}{{W}_{avg}^{- 1}} ) \qquad [ 2 ]$$

where W is the average latency, w is the metric, or warning factor, and ∇T is the gradient of the observed trend line generated as a curve fit of the measured concurrency and throughput of the system.

Equation [2] can be simplified as:

wf=1−∇T·W_{avg} [3]

The inverse of the gradient ∇T may be considered an effective latency W_{eff} based on the measured values of concurrency and throughput. Thus, equation [3] may be rewritten as:

$$wf = 1 - \frac{{W}_{avg}}{{W}_{eff}} \qquad [ 4 ]$$

The metric w can be compared against a threshold wfₜₕ to determine if the system is operating beyond the optimum or target concurrency. That is, if

wf>wfₜₕ [5]

then the network traffic analyzer 100 may issue a warning to the HTTP server or, in some embodiments, take action to reduce the concurrency of the HTTP server to a level that is below the optimum or target concurrency so that the system resumes operating in accordance with Little's Law.

The amount by which wf exceeds wfₜₕ may provide an objective measure of the degree to which the system is overloaded, and may also be used to predict future system instability, e.g., how long the system can be expected to operate before it will crash under the current load conditions, or simply when a required performance metric, such as a maximum average response time, will be reached or exceeded.

The system response to this condition may be passive or active. For example, in some embodiments, the network traffic analyzer may simply report the value of wf to monitoring software as a metric which could be represented to users of the monitoring software in numerical or graphical form, thus providing an indication as to the overall health of the system.

In some embodiments, once wf exceeds wfₜₕ, the network traffic analyzer may add all subsequent incoming requests into a queue, thereby preventing concurrency from increasing. The instantaneous optimum concurrency has been achieved and will be maintained by releasing queued requests from the queue once each currently processed request completes. Once wf falls below wfₜₕ, then the concurrency limit can be allowed to gradually increase, provided wf remains below wfₜₕ.

An extension of the active solution is that before a request is added to the queue, the network traffic analyzer may check to see how long it would take to serve the request, based on current maximum concurrency, throughput and queue length. If that time is above a specified maximum, then the original request may be discarded and a static HTTP response may be immediately sent back to the client indicating that the server is currently experiencing high demand.

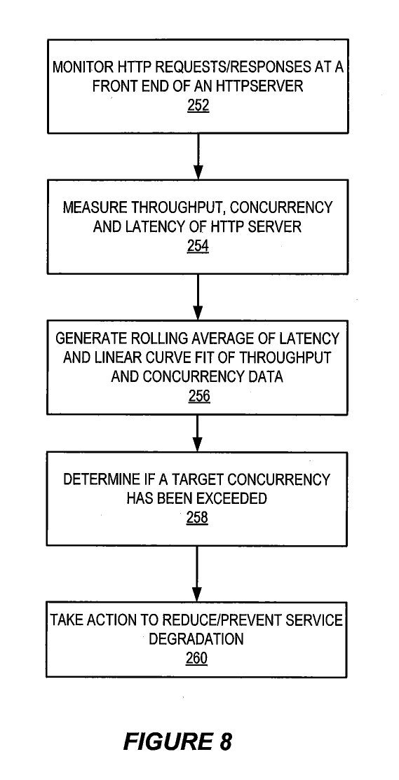

FIG. 8 is a flowchart illustrating operations of a network traffic analyzer 100 in accordance with some embodiments. Referring to FIG. 8, a network traffic analyzer 100 monitors HTTP requests and associated responses at a front end of an HTTP server (block 252). The network traffic analyzer 100 obtains multiple measurements of throughput, concurrency and latency associated with the monitored HTTP requests and responses (block 254). Using this data, the network traffic analyzer 100 generates a rolling average of the last N measurements of latency (block 256). The network traffic analyzer 100 further generates a linear curve fit to the throughput and concurrency data. Using this information as described above, the network traffic analyzer 100 determines if an optimum or target concurrency has been exceeded by the system (block 258). If the optimum or target concurrency has been exceeded, the network traffic analyzer 100 may then take appropriate action to reduce or prevent degradation in service provided by the HTTP server (block 260). Some actions that the network traffic analyzer 100 can take to reduce or prevent degradation in service provided by the HTTP server 120 are described in more detail below.

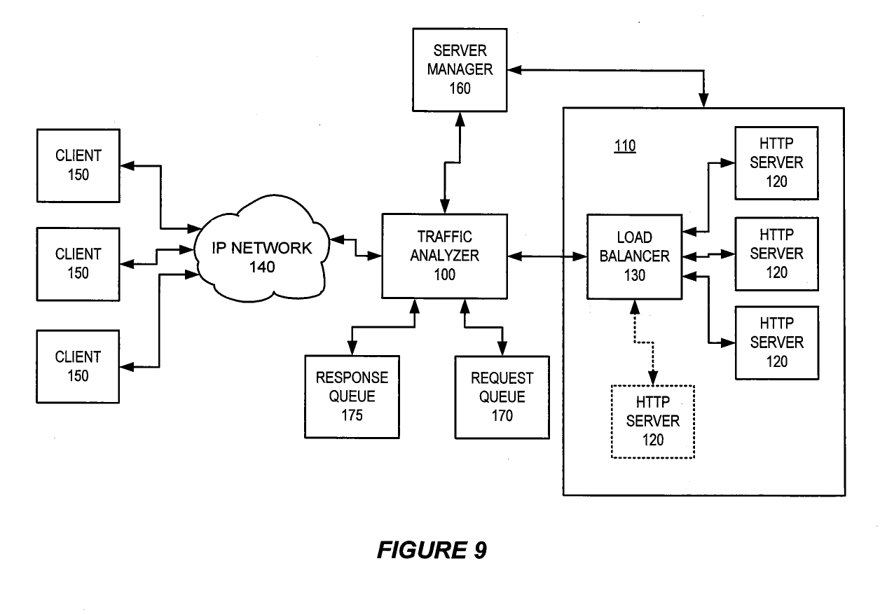

Referring to FIG. 9, in some embodiments, if it is determined that the system has exceeded its optimum or target concurrency, the network traffic analyzer 100 may report the condition to a system administrator component of a server manager 160 so that action can be taken by the server manager in response to the system condition. In some embodiments, the network traffic analyzer 100 may intercept and store new incoming service requests in a service request queue 170, and may release the stored requests once the system is back to operating at an acceptable level of concurrency at which the system operates according to Little's Law.

In some embodiments, the network traffic analyzer 100 may intercept and store outgoing service responses in a service response queue 175, and may release the stored responses at a rate that provides a minimum service level availability (SLA) to the clients 150, but that helps to pace the receipt of further requests from the clients 150 until the system is back to operating at an acceptable level of concurrency at which the system operates according to Little's Law. In some embodiments, the network traffic analyzer 100 may release the stored responses once the system is back to operating at an acceptable level of concurrency at which the system operates according to Little's Law.

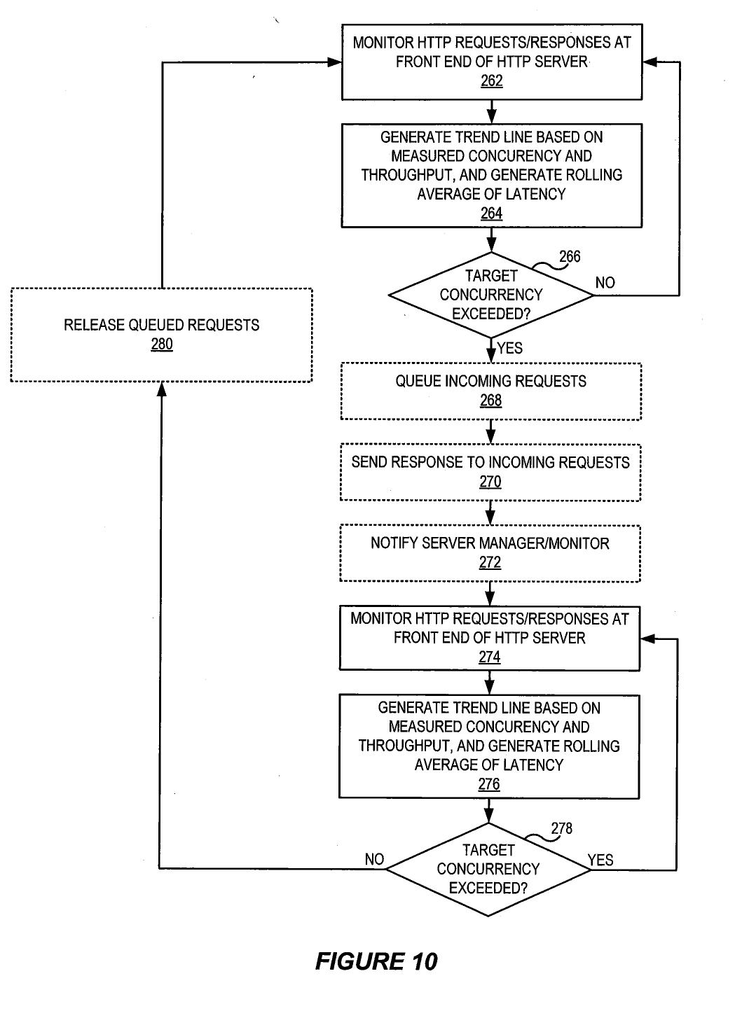

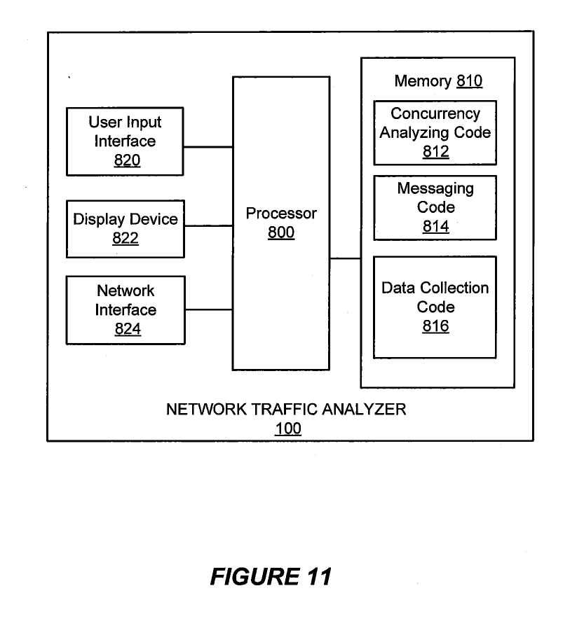

FIG. 10 is a flowchart illustrating operations of a network traffic analyzer 100 according to some embodiments. Referring to FIGS. 9 and 10, operations begin at block 262 at which the network traffic analyzer 100 monitors HTTP requests and responses at the front end of an HTTP server 120 or a server cluster 110 (the system) (block 262). In particular, the network traffic analyzer 100 measures throughput and concurrency of the system at regular intervals. The network traffic analyzer 100 also measures latency of requests/responses processed by the system. In block 264, the network traffic analyzer 100 generates a trend line based on the measured values of concurrency and throughput and calculates a rolling average of the latency.

Using this information, the network traffic analyzer determines if a target or optimal level of concurrency has been exceeded for the system (block 266). If not, operations return to block 262 where the network traffic analyzer 100 continues to monitor the HTTP requests and responses of the system.

If it is determined at block 266 that the target or optimal concurrency of the system has been exceeded, the network traffic analyzer 100 may take one of a number of optional actions in response. For example, the network traffic analyzer 100 may begin to queue new incoming requests in a service request queue 170 (block 268). In some embodiments, the network traffic analyzer 100 may discard new requests until the system is back to operating according to Little's Law. The network traffic analyzer 100 may additionally or alternatively send responses to new incoming requests notifying the requestor that a response to the request may be delayed, or instructing the requestor to try again at a later time (block 270). In some embodiments, the network traffic analyzer 100 may additionally or alternatively notify a server manager 160 of the condition of the system (block 272) so that the server manager can take steps, such as increasing the resources available to the system for processing new incoming requests. Such resources may take the form of CPU utilization level, network bandwidth, and/or memory resources. Such increases may take the form of adding processing capability and/or memory space to a server 120, adding additional servers 120 to a server cluster 110, etc. In some implementations, the network traffic analyzer may itself have the capability to increase resources available to the system in the form of CPU utilization level, network bandwidth, and/or memory resources for processing incoming requests.

In some embodiments, the network traffic analyzer 100 may attempt to manage the concurrency of the system by buffering the incoming requests in the service request queue 170 and forwarding the incoming requests to the system in a non-time varying manner. That is, if it is determined that the system is operating above its target or optimal level of concurrency, the network traffic analyzer 100 may intercept subsequent service requests transmitted to the HTTP server 120 or cluster 110, wherein the intercepted service requests are received as a time-varying random distribution of requests, buffer the requests, and transmit the intercepted subsequent service requests to the HTTP server 120 or cluster 110 as a homogeneous sequence of non-time-varying requests. In this manner, service requests are received by the HTTP server 120 or cluster 110 in a paced manner, which may allow the HTTP server 120 or cluster 110 to process the requests in accordance with Little's Law.

After taking appropriate action, the network traffic analyzer 100 may resume monitoring the HTTP requests and responses of the system to measure the throughput, concurrency and latency of requests/responses (block 274) and calculate the rolling average latency and generate a new trend line based on the measured values of concurrency and throughput of the system (block 276).

In other embodiments, the network traffic analyzer 100 may queue or discard enough new responses that the concurrency of the system remains just below the last concurrency before the system was determined to be operating beyond its optimum or target concurrency. This may keep the system stable until a longer term solution can be implemented, for example, by adding additional processing capability to a server or server cluster.

FIG. 8 is a block diagram of a device that can be configured to operate as the network traffic analyzer 100 according to some embodiments of the inventive concepts. The network traffic analyzer 100 includes a processor 800, a memory 810, and a network interface which may include a radio access transceiver 826 and/or a wired network interface 824 (e.g., Ethernet interface). The radio access transceiver 826 can include, but is not limited to, a LTE or other cellular transceiver, WLAN transceiver (IEEE 802.11), WiMax transceiver, or other radio communication transceiver via a radio access network.

The processor 800 may include one or more data processing circuits, such as a general purpose and/or special purpose processor (e.g., microprocessor and/or digital signal processor) that may be collocated or distributed across one or more networks. The processor 800 is configured to execute computer program code in the memory 810, described below as a non-transitory computer readable medium, to perform at least some of the operations described herein as being performed by an application analysis computer. The computer 800 may further include a user input interface 820 (e.g., touch screen, keyboard, keypad, etc.) and a display device 822.

The memory 810 includes computer readable code that configures the network traffic analyzer 100 to monitor requests/responses transmitted to an HTTP server and determine whether or not the HTTP server has exceeded a target or optimum level of concurrency. In particular, the memory 810 includes concurrency analyzing code 812 that configures the network traffic analyzer 100 to determine if the HTTP server is operating beyond a target or optimal concurrency, messaging code 814 that configures the network traffic analyzer 100 to respond to requests and to send messages to a server manager 160 when the HTTP server is determined to be operating beyond a target or optimal concurrency, and data collection code 814 that configures the workload scheduling computer 100 to measure concurrency, throughput and latency associated with requests/responses processed by the HTTP server.

A method of modeling the average throughput of requests at a server will now be described.

To determine the throughput, it is needed to count how many requests arrive per unit time. It can be assumed that the requests which arrive in each window, k, follow a Poisson process, i.e., the inter-arrival times of the requests are random and independent of one another. A characteristic of the Poisson distribution is that the variance is equal to the mean. Simplifying to the context of one sampling window—this means that the error is equal to the square root of the number of events recorded in each sampling window:

σ(k)=\sqrt{k} [6]

For example, if 100 requests are counted in a given sampling window, then the real average is most likely to lie between 90 and 110, a 10% error. If the sampling window is increased four times and 400 requests are recorded, then the real average is likely to be between 380 and 420, a 5% error.

It can be seen that increasing the window size reduces the error, but it also slows the reaction time of the system. What is needed is a solution that will give a quicker response time without reduced accuracy.

One solution is to use a weighted rolling average, whereby the average throughput is continually updated such that the more recent values have a higher weighting than older values which decay with time and indeed relevance. This can be expressed mathematically as:

$${eps}_{new} = {eps}_{measured} ( \frac{1}{{t}_{avg}} ) + {eps}_{old} ( 1 - \frac{1}{{t}_{avg}} ) \qquad [ 7 ]$$

where eps_{measured} is the number of events counted in the previous sampling window, eps_{new} is the new average number of events per sample, eps_{old} is the previous average value and t_{avg}⁻¹ is the weighting factor.

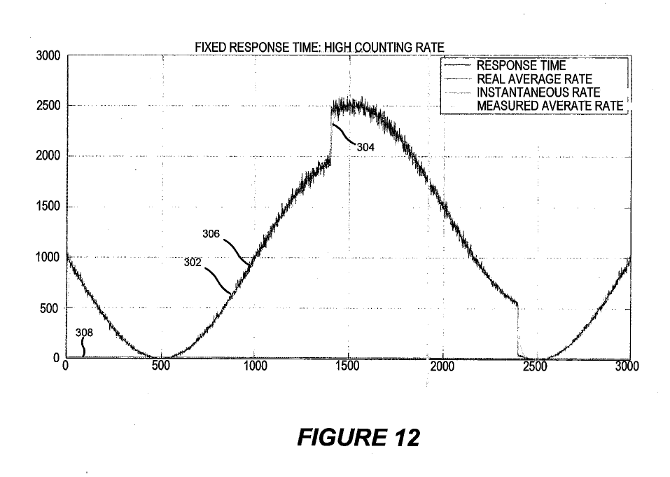

The advantage with this approach is that it starts to react immediately when eps_{measured} changes, taking the time of t_{avg} to fully react, where the unit of t_{avg} is one sampling duration. The sampling window duration and error have been decoupled. FIG. 12 is a simulation graph that shows the behavior of the system when given a sinusoidally varying input with added noise with a spread in accordance with a Poisson process. Additionally there is a positive and a negative step change in the input. The plot shown in FIG. 12 uses a relatively fast reaction time (t_{avg}=10).

The graph in FIG. 12 shows a real average event rate 306, an instantaneous event rate 302 which tracks the real event rate with the simulated error, a measured average event rate 304 which lags the instantaneous event rate, and a response time 308. The sine wave is sampled regularly 3000 times, with each sample being used to denote the number of events which could occur in a hypothetical system being modeled, for example HTTP requests processed.

In this way, the system can be tuned to find the optimal balance between noise rejection and accuracy to the system being monitored.

Looking at the plot of FIG. 12, it is possible to make two observations. First, the reaction time, or error tolerance is constant (tavg=10) yet as mentioned earlier, the error is proportional to the event rate. Second, the step response is the same both at a high event rate as at a low event rate.

Changes of low statistical relevance are in most cases of low practical relevance, and therefore the response time should be correspondingly lower to iron-out such low-level glitches. Both observations indicate that the response time should not be constant but a function of the event rate. A derivation of t_{avg} based on the current average rate with a specifiable fractional error is presented below. As mentioned earlier, it can be assumed that the events arrive following a Poisson process such that:

σ(k)=\sqrt{k} [8]

Events in a sampling window are defined as the rate multiplied by the time window duration:

$$k = \frac{dk}{dt} . Δ t Time period \\ ▲\_rate \qquad [ 9 ]$$

As t has no uncertainty σ(k) can be expressed as:

σ(k)=σ(dk/dt·Δt)=σ(dk/dt)Δt [10]

Fractional error is defined as the ratio of the error to the true value, so the fractional error in the event rate can be written as:

$$\begin{matrix}f = \frac{σ ( rate )}{rate} = \frac{σ ( rate )}{rate} . \frac{Δ t}{Δ t} \\ = \frac{σ ( k )}{rate Δ t} \\ = \frac{\sqrt{( k )}}{rate . Δ t} \\ = \frac{\sqrt{( rate . Δ t )}}{rate . Δ t} \\ = {( rate . Δ t )}^{- 1 / 2}\end{matrix} \qquad [ 11 ]$$

Now having defined the fractional error, Equation 11 can be rearranged to find Δt as follows:

$$Δ t = \frac{1}{{f}^{2} . rate} \qquad [ 12 ]$$

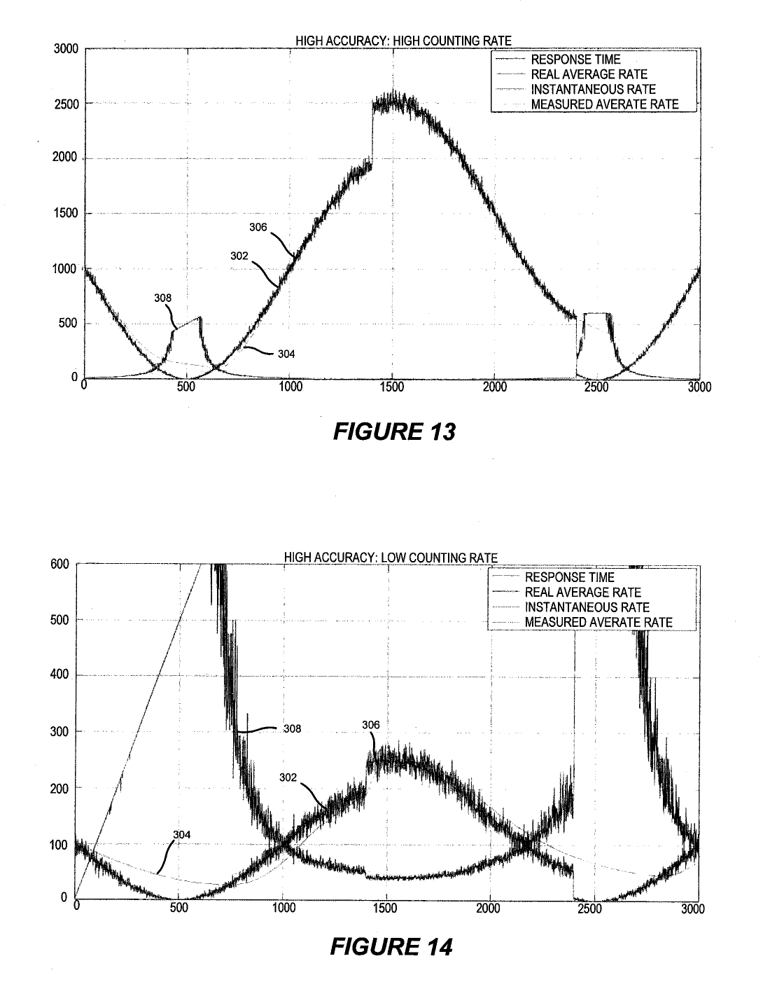

Using the relationship between time, fractional error and rate shown in Equation 12, the reaction time, t_{avg}, can be defined. FIG. 13 shows the rolling average calculated using the same input conditions as used in FIG. 12, but using the above derivation of t_{avg}. As can be seen in FIG. 13, at low event rates the reaction time is low: the error is largely rejected and the step response is slow. At higher event rates the reaction time is much faster; while the uncertainty is equal in proportion to the average event rate as at lower rates, the absolute changes are high and therefore important. The system now duly responds to these changes as required.

FIGS. 13 and 14 show how the system behaves with high accuracy—that is, with longer reaction times to iron out the noise. Of particular note is that FIG. 14 shows the same scenario but at a lower event rate and it can be seen that the system reacts far slower to the fluctuations.

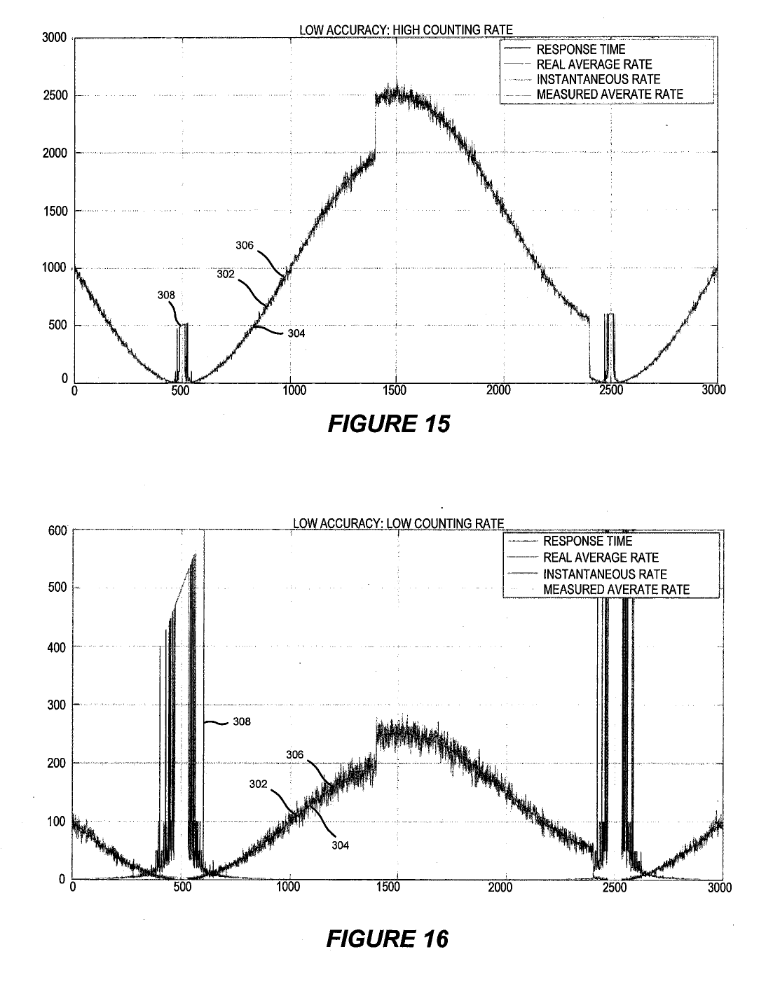

FIGS. 15 and 16 show the system under the same conditions but with a lower accuracy, albeit still derived from the event rate. Comparing to FIGS. 13 and 14, it can be seen that using a lower accuracy results in the rolling average reacting more quickly yet following the fluctuations more closely and therefore a lower error rejection.

Variation of this accuracy can be used to tune the system to find an optimum balance between response time and error rejection.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more non-transitory computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
monitoring, at a network traffic analyzer, service requests transmitted to a network server, and service responses to the service requests transmitted by the network server;
measuring an average latency associated with the service requests, a throughput rate associated with service responses, and a concurrency of service requests being handled by the network server;
determining a relationship of the throughput rate to the concurrency based on a plurality of measurements of the throughput rate and the concurrency;
generating an effective latency based on the relationship of the throughput rate to the concurrency;
comparing the effective latency to the average latency; and
selectively intercepting a subsequent service request transmitted to the network server based on the comparison of the effective latency to the average latency.

2. The method of claim 1, wherein comparing the effective latency to the average latency comprises determining that the effective latency is greater than the average latency by at least a threshold amount.

3. The method of claim 1, wherein comparing the effective latency to the average latency comprises generating a metric based on the effective latency and the average latency and comparing the metric to a target value.

4. The method of claim 3, wherein the metric comprises a warning factor, wf, calculated as:
wf=1−Wavg/Weff
where Wavg is the average latency and Weff is the effective latency.

5. The method of claim 1, further comprising storing a service request that is intercepted in a service request queue as a queued service request.

6. The method of claim 5, further comprising:
determining that the effective latency is no longer greater than the average latency by at least a threshold amount; and
responsive to determining that the effective latency is no longer greater than the average latency by at least the threshold amount, transmitting the queued service request to the network server.

7. The method of claim 2, further comprising:
in response to determining that the effective latency is greater than the average latency by at least the threshold amount, intercepting a subsequent service response transmitted by the network server and storing the service response in a service response queue as a queued service response.

8. The method of claim 7, further comprising:
determining that the effective latency is no longer greater than the average latency by at least the threshold amount; and
transmitting the queued service response to a recipient associated with the queued service response.

9. The method of claim 7, further comprising:
transmitting the queued service response to a recipient associated with the service response after a predetermined delay.

10. The method of claim 2, further comprising:
in response to determining that the effective latency is greater than the average latency by at least the threshold amount, receiving a subsequent service request and responsively transmitting a message to a sender of the subsequent service request indicating that the network server is delayed.

11. The method of claim 2, further comprising:
in response to determining that the effective latency is greater than the average latency by at least the threshold amount, transmitting a message to a server manager indicating that the network server has exceeded a target concurrency.

12. The method of claim 2, further comprising:
in response to determining that the effective latency is greater than the average latency by at least the threshold amount, increasing resources allocated to the network server.

13. The method of claim 12, wherein the resources available to the network server comprise at least one of CPU utilization level, network bandwidth, and/or memory resources.

14. The method of claim 1, wherein determining the relationship of the throughput rate to the concurrency based on a plurality of measurements of the throughput rate and the concurrency comprises fitting a linear curve to the plurality of measurements of the throughput rate and the concurrency and determining a slope of the linear curve.

15. The method of claim 14, wherein an inverse slope of the linear curve is defined to correspond to the effective latency.

16. The method of claim 1, further comprising:
determining that the effective latency is greater than the average latency by at least a threshold amount; and
in response to determining that the effective latency is greater than the average latency by at least the threshold amount, intercepting subsequent service requests transmitted to the network server and transmitting the intercepted subsequent service requests to the network server, wherein the subsequent requests are received as a time-varying random distribution of requests and are transmitted to the network server as a homogeneous sequence of non-time-varying requests.

17. The method of claim 1, further comprising:
determining that the effective latency is greater than the average latency by at least a threshold amount; and
in response to determining that the effective latency is greater than the average latency by at least the threshold amount, intercepting subsequent service requests transmitted to the network server and transmitting the intercepted subsequent service requests to the network server with pacing.

18. A method, comprising:
monitoring, at a network traffic analyzer, service requests transmitted to a network server, and service responses to the service requests transmitted by the network server;
measuring an average latency associated with the service requests, a throughput rate associated with service responses, and a concurrency of service requests being handled by the network server;
determining that a target concurrency of the service requests has been exceeded by a predetermined threshold; and
in response to determining that the target concurrency of the service requests has been exceeded by the predetermined threshold, selectively intercepting a subsequent service request transmitted to the network server.

19. The method of claim 18, wherein determining that the target concurrency of the service requests has been exceeded by a predetermined threshold comprises:
generating an effective latency based on a relationship of the throughput rate to the concurrency, wherein the relationship is based on a plurality of measurements of the throughput rate and the concurrency; and
comparing the effective latency to the average latency.

20. A network traffic analyzer, comprising:
a processor;
a memory coupled to the processor; and
a network interface configured to receive service requests that are transmitted to a network server;
wherein the memory comprises computer readable program code that is executable by the processor to perform:
determining that a target concurrency of the service requests being processed by the network server has been exceeded by a predetermined threshold; and
in response to determining that the target concurrency of the service requests has been exceeded by the predetermined threshold, intercepting a subsequent service request transmitted to the network server.
